(19) United States
(12) Patent Application Publication
(10) Pub. No.: US 2026/0320354 A1
(43) Pub. Date: Oct. 15, 2026

(54) Systems and Methods for Agent System Control of Computing Systems Through Multicontext Representation Generation

(71) Applicant: GDM Holding LLC, Mountain View, CA (US)

(72) Inventors: Victor Carbune, Zürich (CH); Florian Nils Hartmann, Zürich (CH)

(21) Appl. No.: 19/178,254

(22) Filed: Apr. 14, 2025

(51) Int. Cl. G06N 3/0455; G06N 3/0475; G06N 3/08

(52) U.S. Cl. CPC G06N 3/0455; G06N 3/0475; G06N 3/08

(57) ABSTRACT

Systems and methods described herein provide for training a representation generation model on first training data descriptive of context shifts between a plurality of contexts of a computing system and training a plurality of action prediction policies respective to the plurality of contexts on second training data descriptive of a plurality of tasks; initializing a policy routing model using the plurality of action prediction policies; training the policy routing model to route control representations between the plurality of action prediction policies; and performing an inference task using the agent system.

### FIELD

The present disclosure relates generally to artificial intelligence systems. More particularly, the present disclosure relates to systems and methods for agent system control of computing systems through multicontext representation generation.

### BACKGROUND

An artificial intelligence agent (“agent”) can include a set of computer-executable instructions and/or other computer-readable information that is collectively configured to process inputs to generate outputs. For example, an agent can receive data, apply computational processes to analyze the data according to programmed algorithms or models, and produce results that are determined by the parameters and/or structure of the underlying algorithms or models.

### SUMMARY

Aspects and advantages of embodiments of the present disclosure will be set forth in part in the following description, or can be learned from the description, or can be learned through practice of the embodiments.

In an aspect, the present disclosure provides a computer-implemented method for training an agent system. The method includes training a representation generation model on first training data descriptive of context shifts between a plurality of contexts of a computing system and training a plurality of action prediction policies respective to the plurality of contexts on second training data descriptive of a plurality of tasks. The method includes initializing a policy routing model using the plurality of action prediction policies. The method includes training the policy routing model to route control representations between the plurality of action prediction policies. The method includes performing an inference task using the agent system.

In some implementations, the plurality of contexts include independent environments of the computing system.

In some implementations, the policy routing model includes a transformer decoder-only model.

In some implementations, the first training data and the second training data include tuples of observation, state, and action data.

In some implementations, the second training data is transformed to correspond to encoded representations output by the representation generation model.

In some implementations, the first training data includes context shift representations indicative of context shifts within the first training data.

In some implementations, the second training data includes compos control representations that signal composition of objectives from action representations.

In some implementations, the method further includes training the representation generation model and the policy routing model end-to-end using third training data descriptive of tasks that utilize at least two of the plurality of action prediction policies.

In some implementations, training the representation generation model and the policy routing model end-to-end includes assessing a reward based on at least one of a number of actions, a complexity of actions, a quality, or a latency.

In some implementations, the representation generation model includes an encoder-only vision-language model (VLM).

In some implementations, a vocabulary of the policy routing model includes one or more reserved representations.

In an aspect, the present disclosure provides a computing system. The computing system includes one or more processors and one or more non-transitory, computer-readable media storing instructions that, when implemented, cause the one or more processors to perform operations. The operations include receiving a request from a computing system to control the computing system over a plurality of contexts. The operations include outputting, by a representation generation model, a first representation indicative of a first context of the plurality of contexts. The operations include determining, by a policy routing model, to control the computing system using a first expert model based on the first representation, wherein the first expert model is a learned model configured to control the computing system in the first context. The operations include responsive to a context shift of the computing system to a second context of the plurality of contexts, outputting, by the representation generation model, a second representation indicative of the second context. The operations include determining, by the policy routing model, to control the computing system using a second expert model based on the second representation, wherein the second expert model is a learned model configured to control the computing system in the second context.

In some implementations, the representation generation model includes an encoder-only vision-language model (VLM).

In some implementations, the plurality of contexts include independent environments of the computing system.

In some implementations, the policy routing model includes a transformer decoder-only model.

In some implementations, the first training data and the second training data include tuples of observation, state, and action data.

In some implementations, the operations further include training the representation generation model and the policy routing model end-to-end using third training data descriptive of tasks that utilize at least two of the plurality of action prediction policies.

In some implementations, the first training data includes context shift representations indicative of context shifts within the first training data.

In some implementations, the second training data includes compose control representations that signal composition of objectives from action representations.

In an aspect, the present disclosure provides one or more non-transitory, computer-readable media storing instructions that, when implemented, cause one or more processors to perform operations. The operations include receiving a request from a computing system to control the computing system over a plurality of contexts. The operations include outputting, by a representation generation model, a first representation indicative of a first context of the plurality of contexts. The operations include determining, by a policy routing model, to control the computing system using a first expert model based on the first representation, wherein the first expert model is a learned model configured to control the computing system in the first context. The operations include responsive to a context shift of the computing system to a second context of the plurality of contexts, outputting, by the representation generation model, a second representation indicative of the second context. The operations include determining, by the policy routing model, to control the computing system using a second expert model based on the second representation, wherein the second expert model is a learned model configured to control the computing system in the second context.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIGS. 1-3 illustrate block diagrams of example systems according to example implementations of aspects of the present disclosure;

FIGS. 4A-4C illustrate example contexts of example systems according to example implementations of aspects of the present disclosure;

FIGS. 5 and 6 illustrates an example method according to example implementations of aspects of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 is a block diagram of an example networked computing system according to example implementations of aspects of the present disclosure;

FIG. 15 is a block diagram of an example computing device according to example implementations of aspects of the present disclosure; and

FIG. 16 is a block diagram of an example computing device according to example implementations of aspects of the present disclosure.

### DETAILED DESCRIPTION

There is an increasing interest in computer control capabilities by agent systems through the use of foundation models. Foundation models can control computing systems by user interface (UI) control, which refers to the control of these computing systems through user input interfaces generally designed for human interaction (e.g., as opposed to direct interfaces such as application programming interfaces or data interfaces). For example, a user input interface may provide for a user to “scroll” or “click” using a user input device such as a computer mouse or trackpad. As another example, a user input interface may provide for a user to type or otherwise interact with the computing system through a user input device such as a keyboard. Other examples of computing system control by user input devices can include playing computer games (e.g., via controller, keyboard and mouse, voice input, etc.), browsing internet pages, filling out digital forms, and so on. Intuitively, this form of computing system control provides for an agent system to control another computing system as if the agent system were a human operator. Control of computing systems using user input interfaces can be appealing in providing synchronization between control by human users and agent systems, improving accessibility, providing for agent systems to control computing systems that do not have other forms of interfaces, and by augmenting human control capabilities to assist users with various control operations, such as allowing users to automate tasks.

Many computing system control tasks can require multiple levels of reasoning to perform. For instance, using an application can require reasoning about both the high-level objective and the low-level actions (e.g., scrolling/typing) that are required to implement the objective. Contemporary efforts at computer control are focused on predicting low-level actions. At best, these approaches may be adequate for simple tasks, but may struggle with more challenging tasks. Furthermore, these approaches struggle when tasked with simultaneously controlling multiple applications or contexts, such as controlling a game with an accompanying chat window or chat application, or filling out a form while browsing a webpage. Additionally and/or alternatively, the context(s) may relate to control of the computing system itself (e.g., the operating system, firmware, BIOS/bootloader, or other system-level contexts). Additionally, training a model on a mixture of tasks can regress performance on individual tasks due to the different natures, observation spaces, and action spaces of each task.

The present disclosure provides improved techniques for computing system control through the use of improved action spaces and a routing mechanism between learned specialist policies. Models can operate in an appropriate action space to select actions responsive to the granularity required by the current context. The present disclosure thereby provides improved efficiency and quality over existing approaches. As one example, the present disclosure provides for a computer control model to operate fluently in a variety of control applications. Applications of the present disclosure can provide for control of simple applications that are relatively latency-insensitive (e.g., navigating a web page) as well as highly latency-sensitive, complex applications, such as computer games or robotics control, using a single model. For each task, a model can learn independent action prediction policies.

In one example implementation, an agent system according to the present disclosure can include a representation generation model, such as an encoder-only vision-language model (VLM), that embeds text data, audiovisual data, and/or other suitable input data for a task. The representation generation model can output intermediate representations (e.g., vector representations, tokens, etc.) of the input data in response to the input data. The intermediate representations can be discrete or continuous. Additionally and/or alternatively, the agent system can include one or more decoder models (e.g., a decoder-only transformer model). In some implementations, the one or more decoder models can comprise a mixture of experts (MoE) model. The MoE model can encompass the one or more decoder models and/or a trainable routing mechanism that routes each representation (or other division of data) to an appropriate decoder model for handling the representation.

During training of the agent system, the representation generation model can be trained in an unsupervised manner on training data descriptive of trajectories over a plurality of operating contexts. For instance, the training data can include available data, such as audiovisual data or control input data, which is captured as control switches between the operating contexts. The training dataset can include sequences of tuples of [(observation, state, action)]. For example, the training data may include a first portion that is directed to control of a first operating context and a second portion that is directed to control of a second operating context over a sequence, with a transition portion where the controller switches between the first operating context and the second operating context. This transition portion is not necessarily equal in complexity to the first portion and second portion, and may be relatively simple (e.g., a single low-level action). In some implementations, context shift representations corresponding to context changes or other categories can be added to the training data to more explicitly signal context changes to the model during training. For example, in training data depicting control of a game and chat window, representations such as “control_game” or “control_conversation” can respectively signal when the context changes between the game and chat window. The representation generation model can therefore understand the level of reaction that a context requires in response to an action. For example, in a context such as a word processing application, moving the mouse may have little to no effect whereas keystrokes may have a more significant effect. By training on training data depicting this word processing application, the model can better understand the results of action representations.

As used herein, an operating context refers to a context or environment in computing control that is divisible from other contexts on a common computing system. A context may be operated independently of other contexts. For example, a context may be an application on a computing system, a base context (e.g., an operating system), a window or view pane of an application, or similar computer program. A context may, for example, have a respective stack, parameters, input and/or output data, thread(s) on a processor, or other computing resources. Furthermore, in some cases, a single application may define multiple contexts. For example, an internet browser may provide for multiple “tabs” to be grouped in a single application to provide for a user to efficiently swap between multiple webpages. In some implementations, a group of one or more tabs could be considered a separate context from a second group of one or more tabs. As another example, a computer game may define a chat window context that is separate from the main context (e.g., the game itself).

Additionally, one or more action prediction policies can be trained on training data descriptive of control actions for a variety of tasks. This training data can be, for example, tuples of [(observation, state, action)] sequences. Additionally and/or alternatively, this training data can include the same training data as that used to train the representation generation model and/or different training data than that used to train the representation generation model. In some implementations, the training data can be transformed to use the representations of the representation generation model for consistency with the eventual input data of the action prediction policies. The training process can provide N unique policies that route representations (e.g., encoded outputs) to a particular action. In some implementations, one or more reserved representations are included in the vocabulary of the policies (e.g., in the training data). The reserved representations may be representations that as of the time of training the action prediction policies are not necessarily assigned a meaning. These representations may be, for example, extraneous representations that are not assigned meaning during training or dedicated representations that are omitted from being considered by the initial policies. These reserved representations may not be trained on due to a lack of available training data depicting a scenario in which the reserved representations may be useful, or a lack of a useful training objective. After deployment, however, the systems and methods described herein can utilize the reserved representations in responding to rare context shifts or scenarios not encountered in the training data. The reserved representations can be control tokens (e.g., hard tokens), embeddings (e.g., soft tokens) or other suitable representations.

Additionally, one or more decoders can be initialized based on the one or more action prediction policies. For example, in some implementations, N unique decoders can be initialized based on the N action prediction policies. The one or more decoders can be initialized as a mixture of experts (MoE) with a routing mechanism. The routing mechanism can be, for example, a switch transformer model or other routing algorithm.

During training, the routing mechanism of the one or more decoders (e.g., the MoE decoder(s)) can be trained to route encoder-generated representations (and/or representations) to an appropriate expert model configured to operate over a particular domain or type of action policy. Action-specific representations can be added to the training data used to train the routing mechanism. The inclusion of action-specific representations in the training data can provide for the routing mechanism to learn to compose higher-level objectives of lower-level actions. Example action-specific representations can include a representation signaling the beginning (e.g., a “wait_action” representation) or the end (e.g., a “compose_action” representation) of a particular set of actions corresponding to an objective.

In addition to and/or alternatively to training the representation generation model and the routing mechanism, the system may be trained end-to-end using reinforcement learning to introduce additional loss types that are non-differentiable. These additional loss types can encourage the system to optimize routing. In one example, a reward during the end-to-end training can be based on a number of actions. For example, the reward can be inversely correlated to a number of actions (e.g., where fewer actions results in a greater reward). As another example, a reward during the end-to-end training can be based on a quality and/or a latency of the system. For example, a reward for quality can be directly correlated with quality (e.g., where higher quality results in a higher reward) and/or a reward for latency can be inversely correlated with latency (e.g., where lower latency results in a higher reward). Additionally or alternatively to rewards, penalties may similarly be assessed based on metrics such as quality, latency, or number of actions. Additionally and/or alternatively, penalties may be assessed based on complexity of actions, such as rewarding or penalizing a relatively simple function call vs. a control action made up of numerous smaller operations. Furthermore, in some implementations, such as those including reserved representations, a training mechanism can make use of various training algorithms such as supervised fine-tuning (SFT), reinforcement learning (RL), or Bandit to train the action policies using the reserved representations (e.g., task type, action type).

The training datasets used to train the system end-to-end can include training data descriptive of tasks that cross the expertise of greater than one action policy. For example, the training data can be descriptive of controlling a user interface including multiple “tabs” or other sub-contexts. As another example, the training data can be descriptive of operating a computer game via the user interface of the game. Operating the computer game can include switching between the game itself, a multiplayer chat window, and/or a game menu for configuring options within the game. As another example, the training data can be descriptive of live environments involving control of tasks requiring environment switching, such as opening a webpage containing an interface to an agent system and instructing the agent system to perform tasks.

In one example implementation, the present disclosure can more efficiently generate control actions by considering the objective as a whole in generating low-level control representations. For example, systems and methods according to example aspects of the present disclosure can generate a drag action from one position on a screen to another without requiring the generation of intermediate positions between the two positions, by considering the objective to be accomplished (e.g., dragging an item) rather than individual actions at a particular granularity.

As another example, the present disclosure can provide for in-application mode switching from a first context to a second context. Consider, for example, the case of an agent system controlling a computer game with a menu screen. Computer control agents can be expected to provide for both playing the game itself, which may require low-latency processing due to the high refresh rate (or “framerate” in reference to display on a monitor or screen) of the internal state of the game, and configuring the game (e.g., setting player name, using a chat window, setting rendering options, etc.) through in-game menus and windows. By training on multiple contexts with context switch representations, the agent system can recognize changes in context and toggle between multiple policies in response to the changes in context.

As another example, consider the case of switching between input types (e.g., between typing, handwriting, gesturing, etc.). When inputting content into an application, the application may at times request that the controller (e.g., the agent system) input content in a specific format or type. For example, a notetaking application may provide for inputting content by drawing, whereas a form may accept input by typing or gesture-typing. When the requested input type changes due to a change in context, the systems and methods described herein can recognize the change in context and responsively provide for generating different output types. Furthermore, the systems and methods described herein can provide for composing low-level actions (e.g., taps) into higher-level strokes and gestures.

As another example, the present disclosure can provide for in-application mode switching between input types such as game controller inputs. For example, some computer games can concurrently support multiple input types, such as keyboard and mouse or specialized controller/gamepad inputs. These computer games may also provide for dynamically switching between input types, such as, for example, by registering a keyboard/mouse input or gamepad input without significant disruption to the user. It may be effective for a user to seamlessly control different aspects of the game with different input types. As one example, an open world action game may include an on-foot or first-person character movement portion where a user may prefer to control the character with one input type (e.g., a gamepad) and a menu portion where a user may prefer to control the character with another input type (e.g., a keyboard and mouse). For example, a controller input may be preferable due to improved fluidity available to analog joysticks, variable triggers, or other control mechanisms generally available on controllers. These aspects may be beneficial for portions of the game involving movement of a character, such as on-foot portions or vehicle driving portions. As another example, keyboard and mouse input may be preferable due to enhanced precision provided by mouse movement for certain aspects such as menu control, puzzle/strategy sections, construction portions, and so on. The present disclosure can provide for generation of tokens composed of multiple input types (e.g., by predicting across a token vocabulary composed of multiple input types), thereby improving control capability of computing systems.

Example aspects of the present disclosure can provide a number of technical benefits, including improvements to various computer technology-related fields such as, but not limited to, machine learning, control of computing systems, and data processing. As one example, the present disclosure provides improved latency and quality of agent systems in computer control tasks. As one example, as an agent system navigates through different contexts, the agent system can provide improved responsiveness to the particular context it is in by outputting control representations that cause a shift in the action policy model used for controlling that context. As another example, the agent system may be enabled to output action representations that pause or suspend control of the context for a given representation (e.g., a wait representation), instead allowing the agent system to accumulate additional observations and provide more informed (e.g., and accurate) predicted representations at subsequent predictions.

Various example implementations are described herein with respect to the accompanying FIGS.

### Example Agent Systems and Architectures

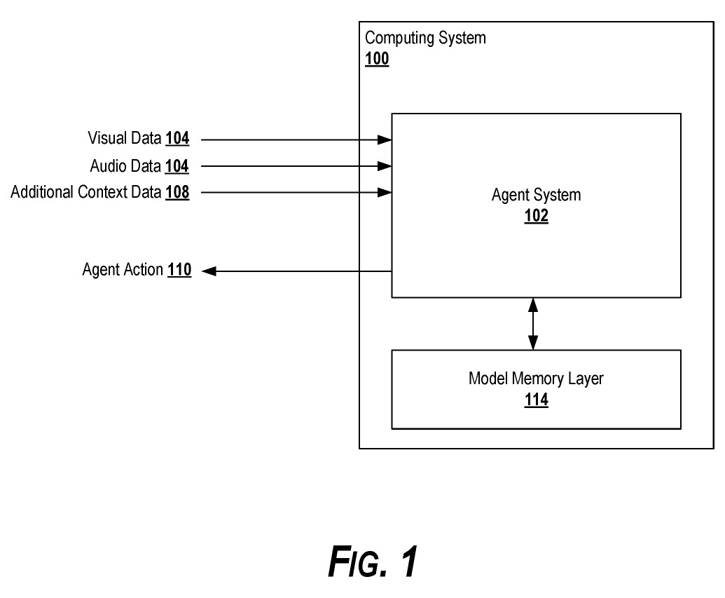

Referring now to FIG. 1, a block diagram illustrates an example computing system 100 configured to implement an agent system 102, according to example implementations of aspects of the present disclosure. The depicted computing system 100 is designed to receive multiple types of input data, process this data, and generate outputs that are responsive to the inputs in a contextually appropriate manner.

The agent system 102 within the computing system 100 is configured to receive visual data 104, audio data 106, and additional context data 108. Each type of data is processed by the agent system 102 to facilitate interaction within its operational environment. For example, visual data 104 can include live video streams from a camera or recorded video streams from a web resource, while audio data 106 can include spoken commands or ambient sounds captured by microphones.

Additional context data 108 can include sensor data, textual information, or other forms of digital data that provide further insights into the environment or the context of the interaction. As one example, the additional context data 108 can include sensor data that captures user inputs beyond speech inputs, such as touch-screen inputs, gestures, facial expressions, and/or other inputs. These user inputs can, in some implementations, be merged with other inputs such as visual data 104 to create combined inputs. In one example, a user can be provided with an interface that displays a real-time field of view of the agent system (e.g., which may correspond to visual data 104). The interface can enable the user to “draw” on or otherwise interact with the interface to mark up the real-time field of view. For example, the user could draw an arrow or make a circle to identify a particular object included within the scene displayed on the interface. The user’s graphical input can be added onto or merged with the visual data 104 to form a combined input. For example, the visual data 104 can be amended to include the arrow or circle, which can then be processed by the agent system 102. In such a manner, interactive interfaces can provide the ability for the user to more granularly interact with or identify portions of the environment when querying the agent system 102.

Furthermore, it should be appreciated that in some cases the user will be able to control the type, nature, content, or other characteristics of the visual data 104, audio data 106, and/or additional context data 108. As one example, the user can manipulate a field of view of a camera to alter the content of the visual data 104 that is provided to the agent system 102. Similarly, by speaking into a microphone, the user can provide additional audio data 106 as an input for the agent system 102. The agent system's ability to process and combine visual, auditory, and textual information allows it to generate more comprehensive and nuanced responses, carefully tailored to the user's multi-modal context.

The agent system 102 processes these diverse inputs to generate an agent action 110, which can include an output designed to respond to the processed inputs effectively. As examples, this action can range from textual responses, vocal responses, displaying information, controlling connected devices, or any other form of interaction output that is deemed appropriate based on the input data. Specifically, the agent system 102 can provide concise answers, generate detailed explanations, offer step-by-step instructions, display information through visual highlights or augmented reality overlays, control connected devices, and/or other forms of actions 110.

In some implementations, the agent system 102 can include and use specialized sequence processing models to integrate and analyze the input data. These models are configured to process complex patterns across different data modalities, enabling the agent system 102 to generate more accurate and contextually relevant responses. The sequence processing models may be specifically fine-tuned to handle various interaction dynamics, such as turn-based dialogues or more open-ended conversational formats, enhancing the flexibility and adaptability of the agent system.

Furthermore, the computing system 100 can be connected to a real-time communication framework that facilitates the immediate and efficient exchange of data, including the inputs and outputs to and from the agent system 102. This configuration reduces latency in data processing and response generation.

In some implementations, the agent system 102 can include or have access to a model memory layer 114 or other memory system. The agent system 102 can store and retrieve various types of information to and from the model memory layer 114. For example, the agent system 102 can store past interactions, observations, preferences, and/or information from the environment in the model memory layer 114. The agent system 102 can then recall this information for use in generating new predictions, outputs, or agent actions.

A number of different types of data can be stored in the model memory layer 114. One example of data stored within the model memory layer 114 can include object detections. This can include indexed records of objects that the agent system encounters during its operations, complete with metadata such as timestamps, location coordinates, and/or contextual tags. By archiving these detections, the agent system 102 can recognize and recall objects from a “history” of observed scenes. The agent system 102 can leverage this information to refine interactions and bolster situational awareness, potentially spanning different sessions of user interaction.

As another example data type, the model memory layer 114 can store embeddings of observed visual content, textual content, or other inputs. These embeddings can be low-dimensional numerical representations that encode the essential features of input data into a latent embedding space. The storage of embeddings associated with observed inputs allows the agent system 102 to conduct rapid comparisons and recognition tasks efficiently. In particular, these embeddings, which can be derived from various layer(s) of the agent system’s machine-learned models, can be used to perform similarity searches to facilitate quick data retrieval.

As another example, intermediate model activations can be stored in the model memory layer 114. Capturing and preserving the state of model activations at various stages can enable the agent system 102 to efficiently resume or adjust its processing activities as needed. This feature can be used in scenarios involving long-running or complex processing tasks that may be interrupted or require dynamic adjustments such as resetting the agent system to a prior state associated with a prior time.

As another example, the model memory layer 114 can store raw tokens generated by the agent system’s natural language processing, image processing, or other tokenization mechanisms. For example, a cache of tokens can be stored, with each being associated with a specific timestamp. This data allows for the reconstruction of the sequence of inputs and internal states over time, which can be used to retrieve and replay perceptual inputs associated with a particular timestamp or setting, or to otherwise provide the raw tokens as a contextual input for a later prediction.

By maintaining a repository of these data types, the agent system 102 can be equipped with a knowledge base that supports advanced functionalities such as context-aware computing, personalized interactions, and information retrieval from past observations. For example, upon retrieving stored information from the model memory layer 114, the agent system 102 can integrate the retrieved data into the current processing workflow. This integration can include aligning historical and current data to enhance the accuracy and relevance of the output.

In some implementations, the agent system 102 can include or have access to both short-term and long-term memory components. The short-term memory may be volatile, designed for the temporary storage of recent interactions and sensory inputs. In contrast, the long-term memory may be non-volatile, storing valuable learned information, user preferences, historical interaction data, and significant environmental events for longer-term recall and usage. In addition, the design of the model memory layer 114 can accommodate both structured and unstructured data. As an example, for immediate processing needs, volatile memory such as Random Access Memory (RAM) can be used. As another example, for the purpose of long-term data retention, non-volatile storage solutions such as Hard Disk Drives (HDDs) or Solid-State Drives (SSDs) can be used. Furthermore, the model memory layer 114 can include hybrid memory solutions that combine the rapid access capabilities of RAM with the extensive storage capacity of disk storage, thereby optimizing the performance of the agent system 102 across various tasks.

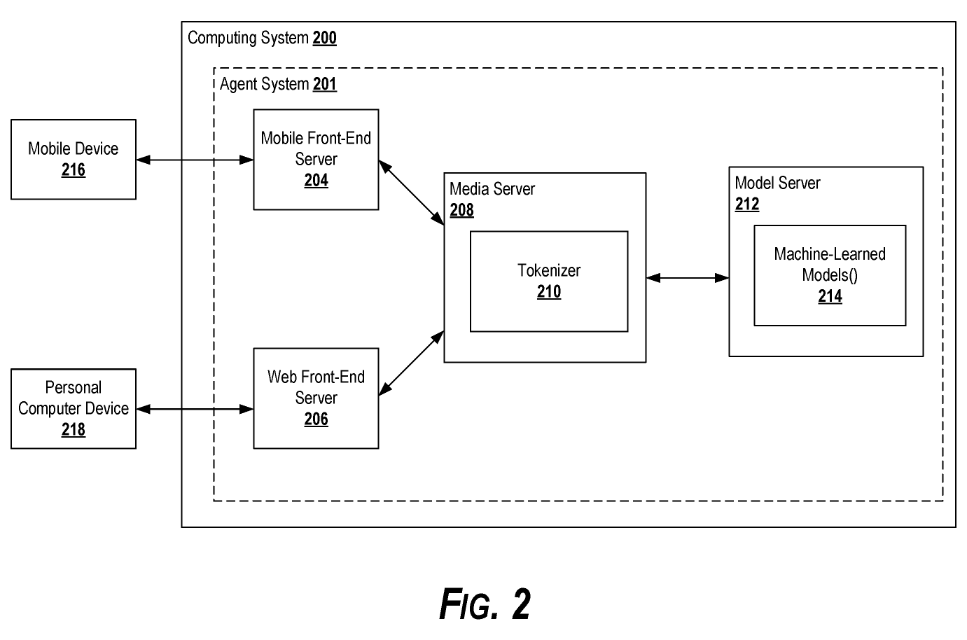

Referring now to FIG. 2, a block diagram illustrates an example computing system 200 configured to implement an agent system 201, according to example implementations of aspects of the present disclosure.

The agent system 201, which is implemented by the computing system 200, can be configured to interface with different types of client devices, including mobile device 216 and personal computer device 218. These devices can send and receive data to and from the agent system 201, allowing for a dynamic interaction between the user and the agent system.

The computing system 200 includes several components that facilitate the operation of the agent system 201. The mobile front-end server 204 and the web front-end server 206 represent the interfaces through which mobile and web-based interactions respectively occur. These servers manage the initial reception of input data from the mobile device 216 and the personal computer device 218, preprocessing this data as necessary before forwarding it to the media server 208.

The media server 208 can act as a central hub within the architecture, receiving processed inputs from both the mobile front-end server 204 and the web front-end server 206. One of the functions of the media server 208 can be to manage the flow of multimedia data, such as video and audio streams, which serve as inputs for the multi-modal capabilities of the agent system 201.

The media server 208 can include a tokenizer 210. The tokenizer 210 can operate to process the incoming multimedia data. For example, the tokenizer 210 breaks down complex data streams into manageable tokens, which are simpler data units that can be more easily processed by machine learning models.

From the media server 208, these tokens are then transmitted to the model server 212, which includes and runs one or more machine-learned models 214. These models 214 are responsible for analyzing the tokens to generate responses that are contextually-appropriate based on the input data. The model server 212 operates asynchronously with the tokenizer 210, ensuring that the tokenization process does not delay the response generation, thus maintaining low latency and high responsiveness of the agent system 201. Stated differently, the timing of the operations of the tokenizer 210 and the model server 212 can in general be established with less interdependence than if the operations of the tokenizer 210 and the model server 212 were sequentially performed by the same machine or machine cluster.

The architecture illustrated in FIG. 2 supports the efficient processing of data by decoupling the roles of front-end processing and model execution. This decoupling allows the system to optimize performance by parallelizing tasks and minimizing the processing time from input reception to response generation. The use of separate servers for handling different aspects of the data flow—front-end interaction, media processing, and model inference—enhances the system’s ability to scale and manage large volumes of interactions simultaneously.

Furthermore, in some implementations, the mobile front-end server 204 and the web front-end server 206 can be specifically configured to support WebRTC protocols or other real-time communication frameworks. This configuration allows these servers to establish peer-to-peer connections with the client devices, facilitating direct data transfer paths that bypass traditional server relay methods. By using WebRTC, the system minimizes the latency typically associated with data transmission over the internet, enhancing the responsiveness of the agent system 201.

Additionally, the media server 208 can be equipped with specialized software components that handle the WebRTC streams. These components can include signal processing units that manage the real-time encoding and decoding of video and audio streams, ensuring that the data remains synchronized and maintains high quality throughout the transmission process. The integration of these components allows the media server 208 to efficiently manage the flow of multimedia data, preparing it for further processing by the tokenizer 210 and eventually the model server 212.

In the architecture illustrated in FIG. 2, the term “server” encompasses a broad range of configurations, each potentially include one or more machines. This includes setups where a server may represent a cluster of machines working collectively to handle specific tasks or workloads. Additionally, the machines involved in such configurations can be either physical machines, consisting of tangible hardware components, or virtual machines, which operate within a controlled software environment on a physical server.

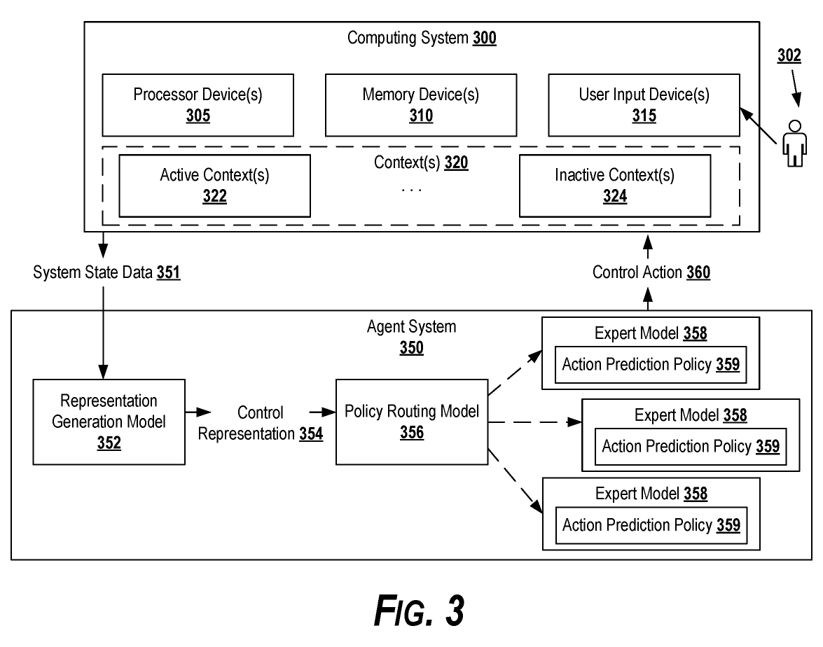

FIG. 3 illustrates an example computing system 300 according to example implementations of aspects of the present disclosure. The computing system 300 can include a processor device 305, a memory device 310, and user input devices 315. The computing system 300 can be any suitable type of computing system or computing device or combination thereof (e.g., a single or multiple computing devices), and may be implemented using any suitable combination of hardware, firmware, and software. As examples, the computing system 300 may be a mobile device (e.g., a smartphone) or a desktop computing device, such as a personal computer, a laptop computer, a server or other machine, or a virtual machine. The computing system 300 can be, for example, a user computing device operated by a user 302.

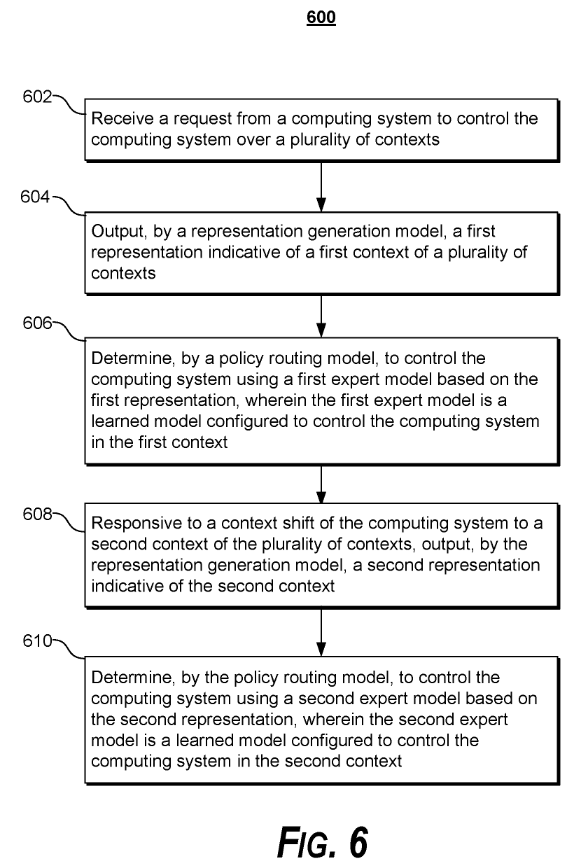

The processor device 305 can be any suitable processor that permits the computing system 300 to perform any of the methods, techniques, and actions, or any steps of methods, described herein. For instance, the processor device 305 may include a microprocessor, a digital signal processor such as a central processing unit (CPU) or graphics processing unit (GPU), an application-specific integrated circuit (ASIC), a field-programmable gate array (FPGA), or other processor device. The processor device 305 can be communicatively coupled to the memory device 310. The memory devices 310 can include one or more memory modules. The memory device 310 can include volatile memory (e.g., RAM) and non-volatile memory (e.g., ROM, flash memory, hard disk) Additionally and/or alternatively, the memory devices 310 can be of one or more types, such as RAM, ROM, flash memory, or disk-based memory. The memory devices 310 can be used alone or in combination. The memory devices 310 can store data and instructions used by the processor device 305. The instructions, when executed by the processor device 305, can cause the processor device 305 to perform any of the methods described herein, such as method 500, as described with reference to FIG. 5.

The user input devices 315 are used by the user 302 to provide inputs that are processed by the computing system 300 to perform tasks such as generating agent actions, receiving information, or other inputs. For example, the user input device 315 may include or communicate with a camera capable of capturing images of a surrounding environment, including still-frame images and video, or other data (e.g., image recognition information regarding objects, people, signs, etc.) that may be incorporated into agent actions. The user input devices 315 can additionally and/or alternatively include a microphone configured to receive speech commands, a touch screen configured to receive touch-based user inputs, a mouse and keyboard configured to receive mouse-based and keyboard-based user inputs, or any other suitable devices facilitating user interaction with the computing system 300. As another example, the user input devices 315 can be or can include a game controller, gamepad, joystick, throttle, pedal(s), steering wheel, wand, or other suitable type of controller.

The computing system 300 can operate within various contexts 320, which can include active contexts 322 and inactive contexts 324. A context 320 can refer to a specific environment or application in which the computing system 300 is operating. For example, the context 320 can be a web browser, a word processing application, a game, or any other software application. For instance, in some implementations, the contexts 320 can be or can include independent environments of the computing system 300. Furthermore, in some implementations, a single environment or application can present multiple contexts 320 for operation by the user 320. The active contexts 322 can include one or more contexts that are currently in use or are receiving user input. For instance, an operating system or other program on the computing system 300 can provide for the user 302 to select one of the contexts 320 as an active context 322 using a graphical user interface (GUI) or other similar interface. An active context 322 can, for example, be highlighted, brought to a foreground area of the interface, or otherwise distinguished from the other contexts (e.g., inactive contexts 324) to inform the user 302 that that context is currently in use. In some implementations, only a single context may be designated as an active context 322 at any one time. Alternatively, multiple contexts 320 can be designated as active contexts 322 at the same time. As an example, an active context 322 can be a web browser that is opened in order to navigate to content on a particular website. The inactive contexts 324 can represent the contexts that are running in the background or are not currently in use. The inactive contexts 324 may not necessarily be idle or out-of-use, but instead may represent contexts that are running but not active, or which are waiting for input or which are available to be activated to perform a task in response to a user input. In some implementations, the contexts 320 may provide for receiving input solely through one or more user interfaces. For example, the contexts 320 may not be configured with an API or other computer control interface providing for direct control of the contexts 320 by the processor device 305.

According to example aspects of the present disclosure, an agent system 350 can be trained and can operate on system state data 351 indicative of the one or more contexts 320 of the computing system 300. For instance, the system state data 351 can describe the active context(s) 322 and inactive context(s) 324 of the computing system 300 (e.g., as provided by the operating system or other processes of the computing system 300). The system state data 351 can be or can include any suitable type of data, such as, but not limited to, audio data, video data, text data, user interface data or other data indicative of the system state of the computing system 300. In some implementations, the agent system 350 can be implemented at computing system 300 (e.g., in memory 310). For instance, in some implementations, the agent system 350 can be communicatively coupled to the memory device(s) 310, such that the agent system 350 can access system state data 351 stored in the memory device(s) 310. Additionally or alternatively, in some implementations, the agent system 350 can be implemented at a second computing system (not illustrated) separate from the computing system 300. The computing system 300 can be in communication with the separate computing system via one or more networks using any suitable wired or wireless techniques. For instance, the system state data 351 can be communicated from the computing system 300 to the second computing system over the one or more networks.

The agent system 350 can include a representation generation model 352 that is trained to output (or generate) control representations 354 based on the system state data 351 (e.g., visual, audio, and/or text data). In some implementations, the representation generation model 352 can be or can include any one or more machine-learned models such as, for example, neural networks (e.g., deep neural networks) or other types of machine-learned models, including non-linear models and/or linear models. Neural networks can be or can include convolutional neural networks or other types of neural networks such as recurrent neural networks (e.g., long short-term memory recurrent neural networks), feed-forward neural networks, or other forms of neural networks. For instance, in some implementations, the representation generation model 352 is or can include an encoder-only vision-language model (VLM). A vision-language model or VLM is a neural network architecture that can process pixel-level data to generate control representations as higher-level, vectorized abstractions. In some implementations, the representation generation model 352 may be a sequence-to-sequence encoder model (e.g., a model that generates outputs as sequences of outputs). Furthermore, in some implementations, the encoder-only VLM can be an encoder portion of a larger vision-language model. For example, the representation generation model can be pretrained as a encoder portion of a VLM. The representation generation model 352 can be any suitable model that encodes the system state data 351 to generate the control representation 354 as a vector or embedding representation of the system state data 351. The control representation 354 can be indicative of a state of the computing system 300 at a particular instance (e.g., a current time step, current processing cycle, current frame, or other time division).

In some implementations, the representation generation model 352 can include a representation exit mechanism for early exiting when the system state data 351 is unchanged. The representation exit mechanism can provide for quickly exiting evaluation of the representation generation model 352 if the representation should be unchanged, thereby conserving resources associated with the representation generation model 352.

The agent system 350 can employ a plurality of expert models 358 configured to process the control representations 354 to generate agent actions 360 (e.g., responses, responses, instructions, etc.) in response to the control representations 354. For instance, the plurality of expert models 358 can include a respective expert model 358 for each type of action that the agent system 350 is configured to perform. For instance, in some implementations, the expert models 358 can execute with respect to respective action prediction policies 359. The action prediction policies 359 can be configured to generate agent actions 360 based on the control representations, in a manner that is appropriate for the respective context 320 for which each action prediction policy 359 provides input. The agent system 350 can employ different action prediction policies 359 for different contexts, and therefore enable the agent system 350 to adapt to different types of inputs and generate different actions across different contexts.

To route a particular control representation 354 to one of the expert models 358, the agent system 350 can employ a policy routing model 356. The policy routing model 356 can receive the control representation 354 from the representation generation model 352 and can route the control representation 354 to an appropriate expert model 358. The policy routing model 356 can use one or more routing mechanisms, such as machine-learned routing mechanisms, deterministic or algorithmic routing mechanisms, or other suitable routing mechanism(s) to determine which expert model 358 is best suited to handle generating a control action 360 responsive to the current active context(s) 322 of the computing system 300 (e.g., as represented by the control representation 354). As one example, the policy routing model 356 can include or use a transformer decoder-only model that routes the intermediate representations to multiple expert action token prediction policies. The transformer decoder-only model can, for example, be a decoder portion of a larger transformer model. As one example, the transformer decoder-only model can be or can be included in a mixture of experts (MoE) configuration. For example, the policy routing model 356 can be pretrained as a decoder portion of a transformer prior to being implemented in the agent system 350. Routing a control representation 354 to a particular expert model 358 can provide for the agent system 350 to adapt to different contexts and tasks.

The control action 360 can be any action that the agent system 350 can perform to control the computing system 300. Example control actions 360 include clicking a button, typing text, scrolling a page, moving a user input device 315 (or simulated user input device 315), or otherwise engaging with the computing system 300. The agent system 350 can generate the control action 360 based on the input data, the control representation 354, and the expert model 358. The agent system 350 can select actions with granularity appropriate for the computing system and environment.

The control action 360 can then be transmitted to the computing system 300. The computing system 300 can receive the control action 360 from the agent system 350 and perform the control action 360 to control operation of the computing system 300. For example, the computing system 300 can simulate a user input to one or more of the contexts 320 (e.g., the active context 322), such as by engaging with one or more application or system windows, based on the control action 360. As one example, if the control action is to click a button, the computing system 300 can engage a user interface in response to the control action to simulate the user 302 clicking the identified button. As another example, if the control action is to type text, the computing system 300 can engage a character input box of a user interface in response to the control action to simulate the user 302 typing the identified text characters. As another example, if the control action is to scroll a window, the computing system 300 can engage with a user interface to simulate the user 302 scrolling the identified window. It will be appreciated that the control actions 360 can cause the computing system 300 to perform any other suitable operations for controlling the computing system 300 in response to the control action 360.

By selecting one of the expert models 358 and/or one of the action prediction policies 359 to generate the control action 360 for each task (e.g., each control representation 354), control of the computing system 300 can be appropriate for the active context(s) 322, even when the active context(s) 322 are modified during operation of the computing system 300. For example, because the agent system 350 can select an appropriate expert model 358 and/or action prediction policy 359 that is appropriate for the active context(s) 322, the control action 360 can correspond to a granularity required by the active context(s) 322, such as, for example, the latency, the fineness of the control action 360 (e.g., the resolution of the controls made in response to the control action 360), an accuracy of the control action 360, or other attributes of the control action 360. Furthermore, this granularity can be adapted to the active context(s) 322. For example, if the active context changes during operation of the computing system 300, a new expert model 358 and/or action prediction policy 359 can be selected based on the change in active context(s) 322. As a result, operation of the computing system 300 can be improved.

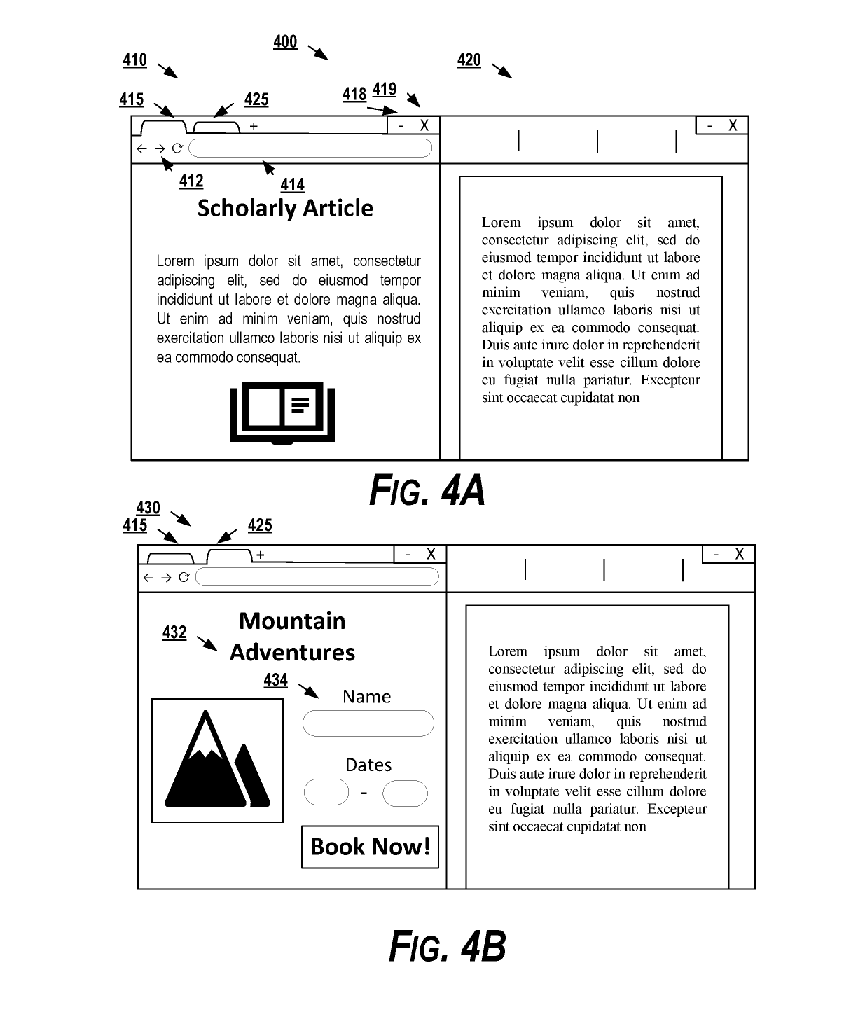

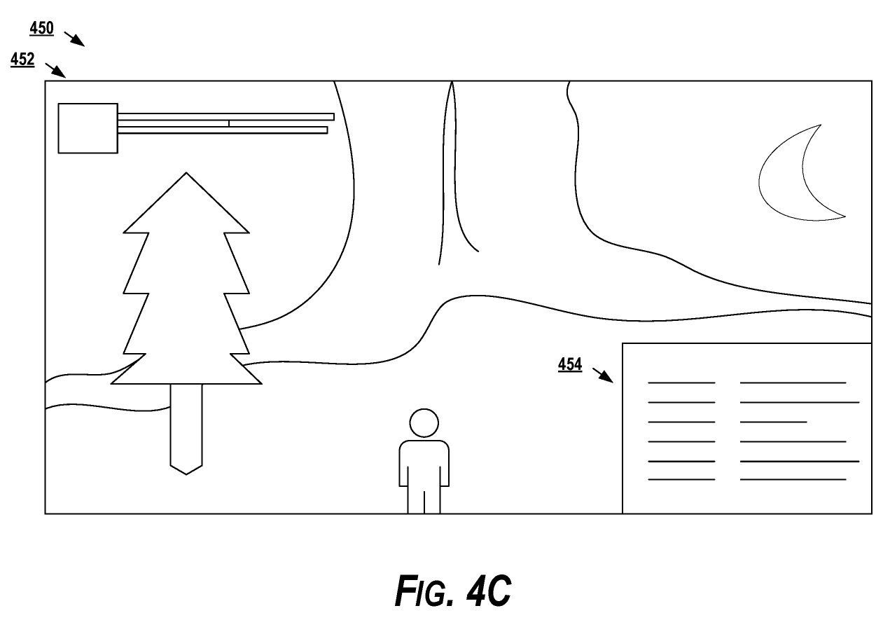

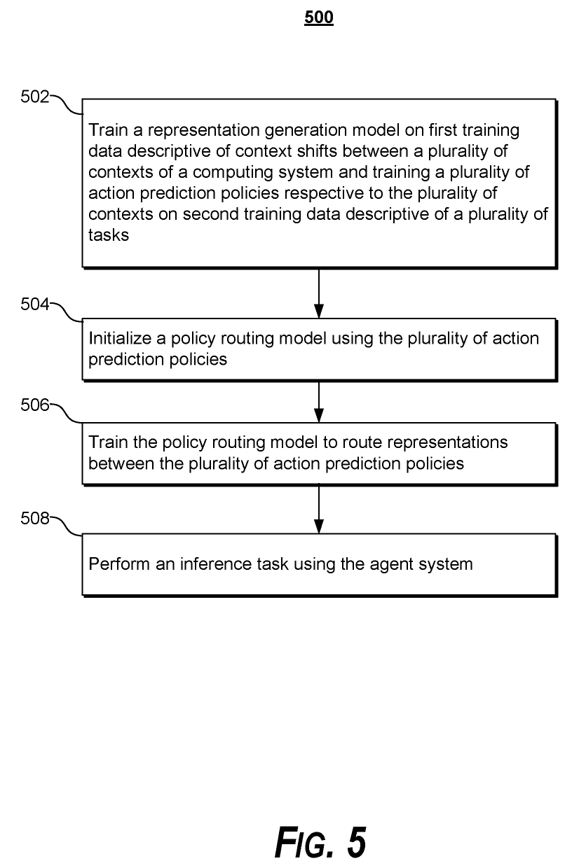

FIG. 4A illustrates an example system 400 capable of provisioning a plurality of contexts. For example, FIG. 4A can illustrate a view or user interface as displayed on a display device of the system 400. The system 400 may be, for example, the computing system 300 of FIG. 3. FIG. 4A illustrates an example first context 410. The first context 410 may be, for example, a tab of a web browser application. The web browser application can provide navigation controls 412 and a navigation bar 414 for navigating between different website pages or other web elements. The web browser application can also have a first tab 415 and a second tab 425, minimize controls 418, and close controls 419 that provide for a user to alter the active context of the system 400. For example, by interacting with the minimize controls 418, the web browser application (and the first context 410) may be brought to a background of the system 400, providing for another context to become an active context. Similarly, by interacting with the close controls 419, the web browser application (and the first context 410) may be closed (e.g., by terminating a process or thread operating on the system 400 associated with the web browser application).

In the example of FIG. 4A, the system 400 can concurrently display a second context 420. In the example of FIG. 4A, the second context may be, for example, a word processing application. The word processing application can provide for a user to read and/or edit a document. In the example of FIG. 4A, for example, the user may be performing research using the first context 410 and editing a document based on the context of the webpage displayed in the first context 410. If the user wishes to employ an agent system to assist in this process, the agent system can desirably be capable of responsively controlling both the first context 410 and the second context 420. For example, controlling the first context 410 using the agent system may include navigating the webpage using various gestures, such as scrolls, clicks, slides, etc., using the navigation controls 412, the navigation bar 414, or other controls provided for in the first context 410 to navigate the Internet, or other similar tasks. Controlling the second context 420 using the agent system may include, for example, editing the document using the keyboard and various other input methods provided by the second context 420, generating text to be inserted into the document (e.g., based on the content of the webpage in the first context 410), or other similar operations. The operations for controlling the first context 410 and the second context 420 may employ significantly different skillsets at the agent system. According to example aspects of the present disclosure, by employing a representation generation model and a policy routing model, as provided herein, to route a control task to one of a plurality of expert models configured for different contexts, the agent system can provide for control of the first context 410 and the second context 420 in a manner that is appropriate for the specific operation and tasks associated with the first context 410 and the second context 420.

FIG. 4B depicts another view of the system 400. In the example of FIG. 4B, the first context 410 has become an inactive context and a third context 430 is displayed in place of the first context 410. The third context 430 may, for example, be a separate context provided by the same web browser application that provides the first context 410. For example, the user may have switched the active context to the third context 430 by interacting with second tab 425. It should be understood that, while FIGS. 4A-4B refer to each tab of the web browser application as separate contexts, in some implementations, the web browser application itself may be considered a single context including each of any tabs or other divisions within the web browser application.

An agent system can require a different skillset to interact with the third context 430 than the first context 410 or the second context 420. Therefore, in some implementations, control of the system 400 in the third context 430 can be performed using a different expert model and/or action prediction policies than the first context 410 or the second context 420. In particular, according to example aspects of the present disclosure, a representation generation model and a policy routing model can be trained to recognize the context shift from the first context 410 to the third context 430, such as by generating a context shift representation indicative of a context shift from the first context 410 to the third context 430 at the representation generation model. Responsive to the context shift representation, the routing mechanism of the policy routing model can determine to shift to a new expert model and/or action prediction policy to be used to control the system 400 in the new (e.g., third) context. As a result, a different expert model and/or action prediction policy may be selected for control tasks associated with the third context 430 as compared to tasks associated with the first context 410. Furthermore, the agent system can receive data from the third context 430, and can perform control actions responsive to the data. For example, controlling the system 400 in the third context 430 can include reading webpage content 432 from a webpage and interacting with input fields 434 provided on the webpage. In the example of FIG. 4B, the agent system can search for vacation bookings using the input fields 434.

FIG. 4C depicts a system 450 according to example aspects of the present disclosure. The system 450 illustrates a view or user interface of an application providing multiple contexts, including a game context 452 and a chatbox context 454. For example, the game context 452 can provide for a user of the system 450 to interact with a game, such as by controlling an in-game character, solving in-game puzzles, or otherwise interacting with the game. The chatbox context 454 can provide for the user of the system 450 to communicate with the game, such as other users of the game, characters within the game, or other entities by reading and entering text, images, or other media into the chatbox context 454. An agent system can require a different skillset to control the game context 452 and the chatbox context 454. Therefore, in some implementations, control of the system 450 in the game context 452 can be performed using a different expert model and/or action prediction policies than the chatbox context 454. In particular, according to example aspects of the present disclosure, a representation generation model and a policy routing model can be trained to recognize the context shift from the chatbox context 454 to the game context 452, such as by generating a context shift representation indicative of a context shift from the chatbox context 454 to the game context 452 at the representation generation model. For example, the agent system may control the game context to achieve objectives within the game, and may output an instruction to shift to the chatbox context 454 to communicate with other game characters, users, or entities. As another example, the user may play the game in the game context 452 alongside the agent system, and the user may switch to the chatbox context 454 and ask the agent system to chat with other game characters, users, or other entities for the user. For example, the user may ask the agent system to communicate information about the user's activity to other users of the game to facilitate collaboration or competition within the game. The agent system can utilize different skillsets to control the game context 452 and the chatbox context 454. According to example aspects of the present disclosure, a representation generation model and a policy routing model can provide for the agent system to improve control of both the game context 452 and the chatbox context 454 by routing control tasks appropriately to an appropriate expert model configured for control of the specific contexts 452 and 454. For example, controlling the game context 452 using the agent system may include solving one or more puzzles in the game context 452, answering questions in the game context 452, or otherwise interacting with the game to achieve one or more objectives in the game. Control of the chatbox context 454 using the agent system may include entering and/or reading text or other information from the chatbox context 454. For example, if a chat session with a game character within the game context 452 has not yet concluded, the agent system can generate a control action 360 including reading from the chatbox context 454 to the game character within the game context 452 to prepare for a next step in the game or chat session. As a result, the agent system can provide improved interfacing and control of the game context 452, the chatbox context 454, or other contexts of the system 450.

As another example, the agent system can control the game context 452 using multiple input types. For example, the agent system can predict a first control action of the game context 452 using a first input type, such as a controller. For example, the agent system can predict the first control action using the first input type based on information from the game context 452, such as information showing that the game context 452 involves control of a game character, movement of an in-game camera, and so on. The agent system can additionally or alternatively predict a second control action of the game context 452 using a second input type, such as a keyboard and mouse. For example, the agent system can predict the second control action using the second input type based on information from the game context 452, such as information showing that the game context 452 involves control of a menu or precise puzzle. The particular control type is not necessarily exclusive, e.g., movement of the game character or control of the menu may in some cases be performed by either the first input type or the second input type. As another example, the agent system can control the game context 452 using a first input type and the chatbox context 454 using a second input type.

FIG. 5 depicts one example method 500 for training an agent system for control of computing systems through multicontext representation generation. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

The method 500 includes, at 502, training a representation generation model on first training data descriptive of context shifts between a plurality of contexts of a computing system and training a plurality of action prediction policies respective to the plurality of contexts on second training data descriptive of a plurality of tasks. The representation generation model can be, for example, the representation generation model 352 of the agent system 350 described with reference to FIG. 3. Additionally and/or alternatively, the plurality of action prediction policies can be the action prediction policies 359 described with reference to FIG. 3. The first training data and the second training data can include any data types (e.g., visual data, audio data, text, etc.) discussed herein and/or any other suitable data. In some implementations, for example, the representation generation model can be trained in an unsupervised manner on training data descriptive of trajectories (e.g., context shifts over time) over a plurality of operating contexts. The first training data and/or the second training data can be, for example, tuples (e.g., sequences of pairs) of at least observation, state, and action data descriptive of a plurality of control requests for the plurality of contexts. The first training data can include context shift representations that correspond to instances where an active context of the computing system has shifted from a first context to a second context. For example, if the first context is a first application and a user clicks on a window associated with a second application, the active context of the computing system may shift from the first application to the second application in response to the user action. The context shift representations can be tokens, symbols, or other data types that uniquely indicate shifts in context. For example, a context shift representation can be a character string having a unique value (e.g., such as "CONTEXT_SWITCH"). As another example, a context shift representation may be a unique value of an embedding or other encoded representation.

In some implementations, the second training data can be transformed to correspond to encoded representations output by the representation generation model. For example, in some implementations, the second training data can be transformed to correspond to a same vocabulary as the vocabulary utilized by the representation generation model and/or the policy routing model. The vocabulary utilized by the representation generation model or the policy routing model can, for example, include tokens or other data that is assigned a unique meaning with respect to controlling the computing system.

Furthermore, in some implementations, the second training data can include additional signals that indicate the structure of higher-level control objectives within groupings of lower-level control actions. For example, in some implementations, the second training data can include composition control representations that signal composition of objectives from action representations. The inclusion of higher-level control objectives in the second training data can encourage the action prediction policies (e.g., and expert models employing the action prediction policies) to generate more coherent control actions when considered in the aggregate over continued operation of a computing system. For example, the action prediction policies can be trained to generate control actions that amount to improved control of the system over multiple control actions forming a higher-level objective, even if the control actions are not individually the most optimal (e.g., the best greedy option) for a single control task. For example, by including groupings of control actions, the action prediction policies may generate a single "drag" control action rather than generating a greater number of click and movement options that may require a greater amount of computing resources to store, transmit, and/or implement than the single drag action.

Furthermore, in some implementations, the representation generation model and the policy routing model can be trained end-to-end. For instance, in some implementations, the representation generation model and the policy routing model can be trained end-to-end subsequent to training the representation generation model on the first training data and/or training the plurality of action prediction policies on the second training data. The end-to-end training may be performed using additional training data (e.g., third training data), which may be or may include some or all of the first training data and/or the second training data. In some implementations, losses, rewards, or other training objectives may be different in the end-to-end training.

For instance, in some implementations, training the representation generation model and the policy routing model end-to-end can include assessing a reward based on at least one of a number of actions, a quality, or a latency. The reward may incentivize the models to generate control actions that score highly in qualities that are valued in a particular context. For example, in a latency-sensitive environment such as a game, the reward may be assessed such that the reward is more dependent on latency (e.g., rewarding low latency) over less valuable qualities such as number of actions. Alternatively, in a quality-sensitive environment such as a word processing context (e.g., for text generation), the reward may be assessed to prioritize quality of control actions over less valuable qualities such as latency.

The method 500 includes, at 504, initializing a policy routing model using the plurality of action prediction policies. The policy routing model can be, for example, the policy routing model 356 of the agent system 350 described with reference to FIG. 3. As one example, initializing the policy routing model can include configuring the policy routing model to route incoming control action generation tasks (e.g., token generation tasks) to a selected expert model of a plurality of expert models configured according to the action prediction policies. For instance, each control action generation task can correspond to a particular time instance, processing cycle, or other division of time or sequence at the computing system. Additionally and/or alternatively, each control action generation task can correspond to a "snapshot" of system state data that is embedded or encoded by control representations from the representation generation model.

The method 500 includes, at 506, training the policy routing model to route control representations between the plurality of action prediction policies. Training the policy routing model can be performed using any suitable approach for training a policy routing model. For example, the policy routing model can be trained to route control representations from the representation generating model to appropriate action prediction policies. As one example, the policy routing model can be trained using training data including control action generation tasks that are labeled with identifiers of an appropriate action prediction policy or expert model for processing the control action generation task.

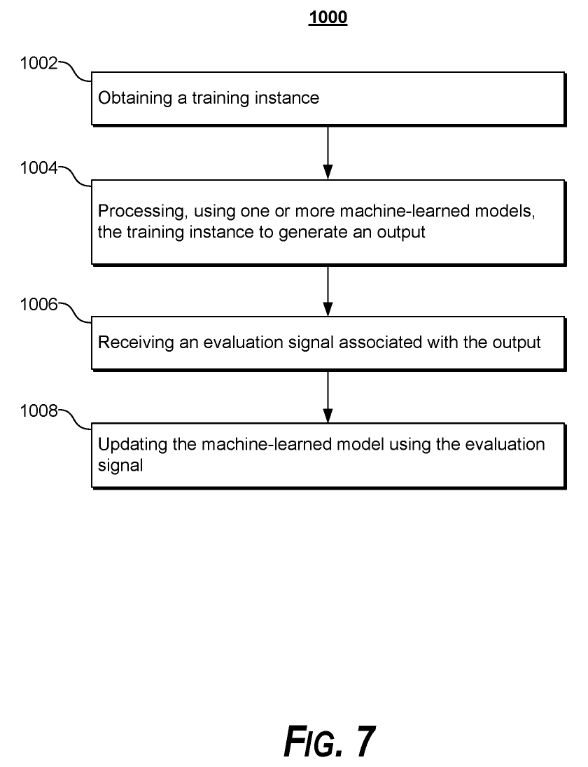

The method 500 includes, at 508, performing an inference task using the agent system. The inference task can be any suitable inference task. As one example, the inference task can include generating a control action using the agent system (e.g., the representation generation model, the policy routing model, and an expert model that is selected based on the action prediction policy used to generate a token for the control action). For instance, in some implementations, performing the inference task can include receiving system state data, and generating the control representations using the representation generating model based on the system state data. As another example, in some implementations, performing the inference task can include selecting one of the plurality of action prediction policies for generating a control action based on the control representations. One example of performing an inference task is described with reference to FIG. 6, and illustrated in the example method 600 below.

FIG. 6 depicts a flowchart of a method 600 for controlling a computing system using the systems and methods described herein, according to example aspects of the present disclosure. One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

The method 600 includes, at 602, receiving a request from a computing system to control the computing system over a plurality of contexts. The request, for example, can be caused by a user instructing the computing system or an agent system in communication with the computing system to use the agent system to control the computing system. The agent may, for example, be the agent system 350 described with reference to FIG. 3. Additionally, the plurality of contexts may be, for example, the contexts 320 described with reference to FIG. 3, such as the first context 410 and the second context 420 described with reference to FIGS. 4A-4B.

The method 600 includes, at 604, outputting, by a representation generation model, a first representation indicative of a first context of the plurality of contexts. The representation generation model can be, for example, the representation generation model 352 of the agent system 350 described with reference to FIG. 3. For example, system state data can be provided from the computing system to the representation generation model as input data. The system state data can include any data, such as, for example audio, video, and/or text data, associated with the present or past operation of the computing system. The representation generation model can then encode the system state data into a control representation (e.g., an intermediate representation or embedding) that is indicative of the first context.

The method 600 includes, at 606, determining, by a policy routing model, to control the computing system using a first expert model based on the first representation, wherein the first expert model is a learned model configured to control the computing system in the first context. The policy routing model can be, for example, the policy routing model 356 of the agent system 350 described with reference to FIG. 3. The policy routing model can determine to control the computing system using the first expert model based on the first representation in any suitable manner. For example, the policy routing model can recognize a control task represented by the first representation, and can determine, based on a learned correlation between the first context and the control task, to control the computing system in the first context using the first expert model. The first expert model can be one of the expert models 358 described with reference to FIG. 3, and can be associated with an action prediction policy that is trained to optimally generate control actions for the particular first context. The first expert model and the first action prediction policy can be learned in any suitable manner (e.g., such as by training in an end-to-end manner and/or supervised training).

The method 600 includes, at 608, responsive to a context shift of the computing system to a second context of the plurality of contexts, outputting, by the representation generation model, a second representation indicative of the second context. For example, system state data can be provided from the computing system to the representation generation model as input data. The system state data can include any data, such as, for example audio, video, and/or text data, associated with the present or past operation of the computing system. The representation generation model can then encode the system state data into a control representation (e.g., an intermediate representation or embedding) that is indicative of the second context. The context shift may be, for example, a shift in an active context of the computing system from the first context to the second context. The context shift may, for example, have occurred at a time subsequent to outputting the first context representation and prior to outputting the second context representation. As one example, a user may have instructed the computing system or the agent system to transition to the second context prior to (e.g., at the time of) the context switch. As another example, the agent system itself may generate an instruction to transition to the second context. In these examples, the context shift may be triggered by activity with respect to the computing system.

The method 600 includes, at 610, determining, by the policy routing model, to control the computing system using a second expert model based on the second representation, wherein the second expert model is a learned model configured to control the computing system in the second context. The policy routing model can determine to control the computing system using the second expert model based on the second representation in any suitable manner. For example, the policy routing model can recognize a control task represented by the second representation, and can determine, based on a learned correlation between the second context and the control task, to control the computing system in the second context using the second expert model. The second expert model can be one of the expert models 358 described with reference to FIG. 3, and can be associated with an action prediction policy that is trained to optimally generate control actions for the particular second context. The second expert model and the second action prediction policy can be learned in any suitable manner (e.g., such as by training in an end-to-end manner and/or supervised training).

The method 600 can, in some implementations, optionally include controlling the computing system using the first expert model or the second expert model. For example, the action prediction policy of the first expert model can generate a control action to the computing system that is based on the first context. For example, if the computing system is operating in the first context, the action prediction policy of the first expert model can generate a control action to the computing system that is based on the first context. As another example, the action prediction policy of the second expert model can generate a control action to the computing system that is based on the second context. For example, if the computing system is operating in the second context, the action prediction policy of the second expert model can generate a control action to the computing system that is based on the second context. Controlling the computing system using the first expert model can include transmitting a control action to the computing system from the first expert model. Controlling the computing system using the second expert model can include transmitting a control action to the computing system from the second expert model.

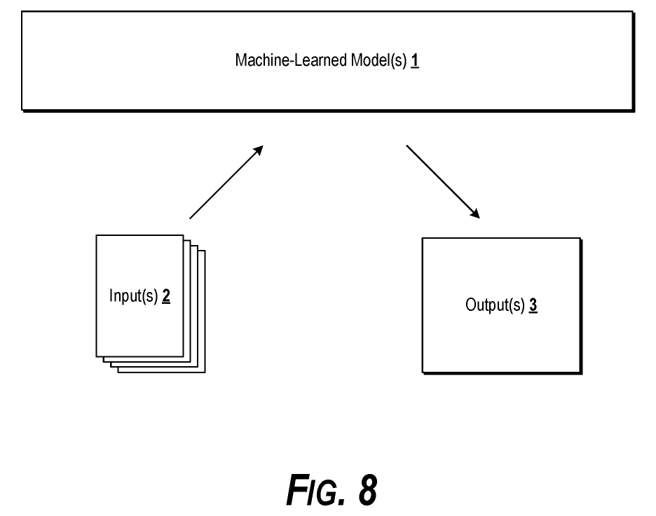

FIG. 7 depicts a flowchart of a method 1000 for training one or more machine-learned models according to aspects of the present disclosure. For instance, an example machine-learned model can include a sequence processing model. One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

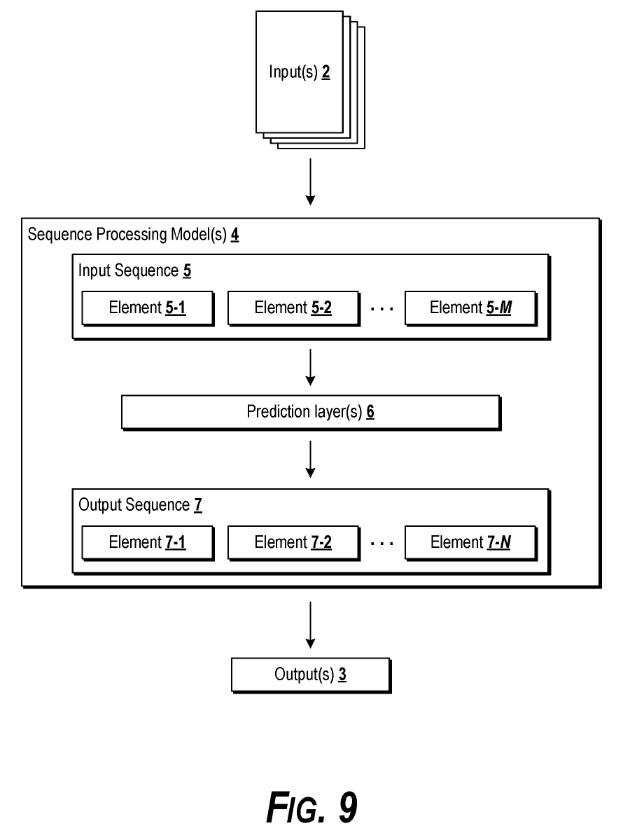

FIG. 8 is a block diagram of an example processing flow for using machine-learned model(s) 1 to process input(s) 2 to generate output(s) 3.

Machine-learned model(s) 1 can be or include one or multiple machine-learned models or model components. The machine-learned model(s) 1 can be or can include, for example, the machine-learned model(s) 214 models employed by agent system(s) 102, 201, 304, 314 and/or 316 of FIGS. 1 - 3. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models. For example, the machine-learned models can be or include transformer models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer’s central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

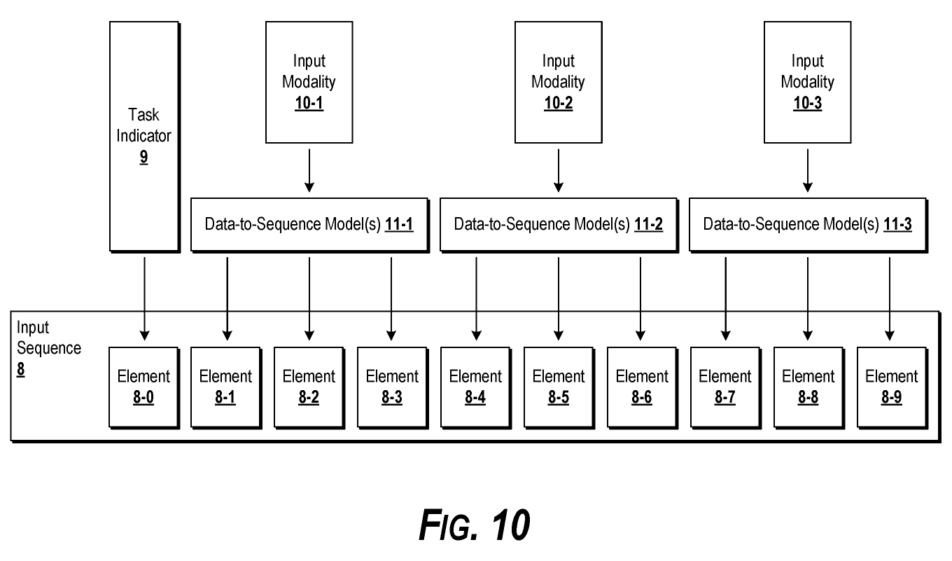

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2Technical Report, Google, https://ai.google/static/documents/palm2techreport.pdf (n.d.). Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image. Other tokenization approaches can be performed as well, including linear projections, non-linear transformations, and/or other data transformations.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via an input sequence 5.

Output sequence 7 can be generated autoregressively. For instance, for some applications, an output of one or more prediction layer(s) 6 can be passed through one or more output layers (e.g., SoftMax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

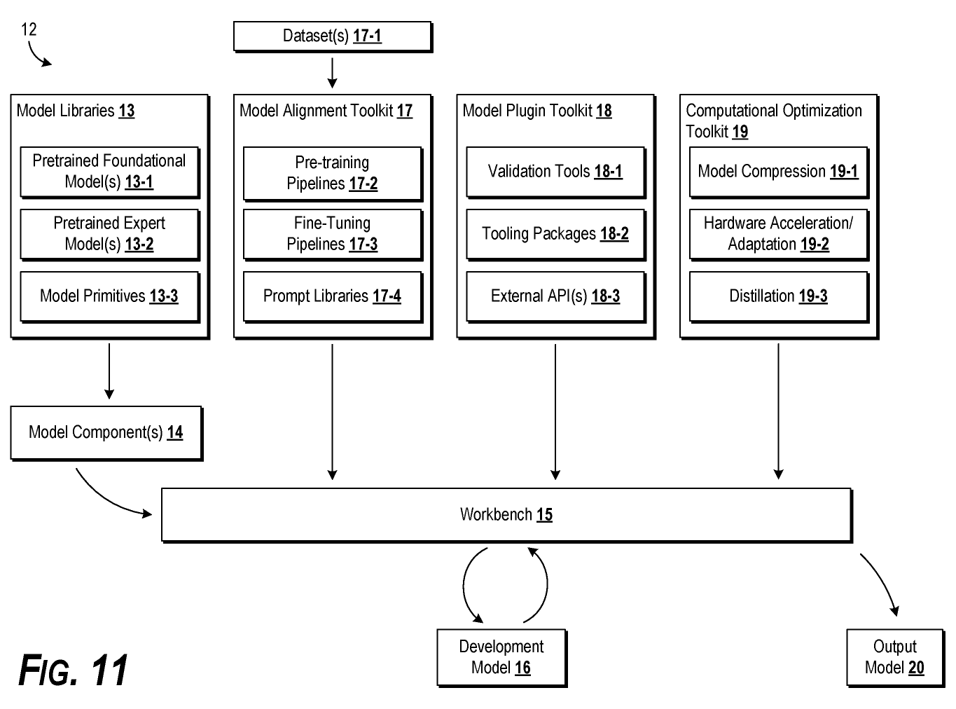

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

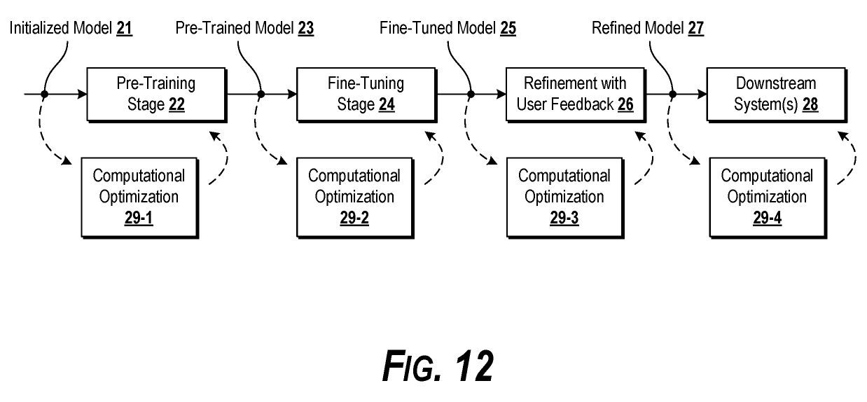

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. As another example, a tool can have a machine-learned model with reduced model overhead compared to a larger machine-learned model. For instance, the model of the tool can be a less sophisticated model than the calling model that is specialized to a particular task or subset of tasks and can require fewer computing resources to produce a usable output. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem or for evaluation of simpler tasks that can be adequately performed by a less sophisticated model.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”). One example tool that can be included in validation tools 18-1 is a routing tool for routing a query from a user to a user-specific memory layer or a public data interface.

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems. As an example, the development model 16 can initiate API calls to one or more public data interface(s) to send or obtain data from one or more public data sources, such as webpages, databases, and so on.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

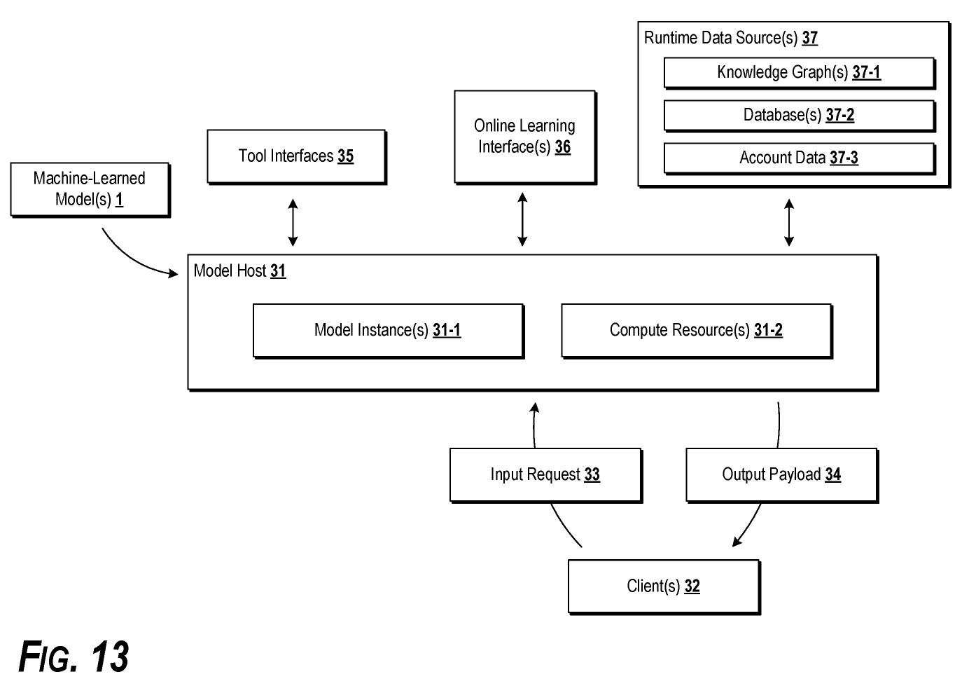

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model. model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

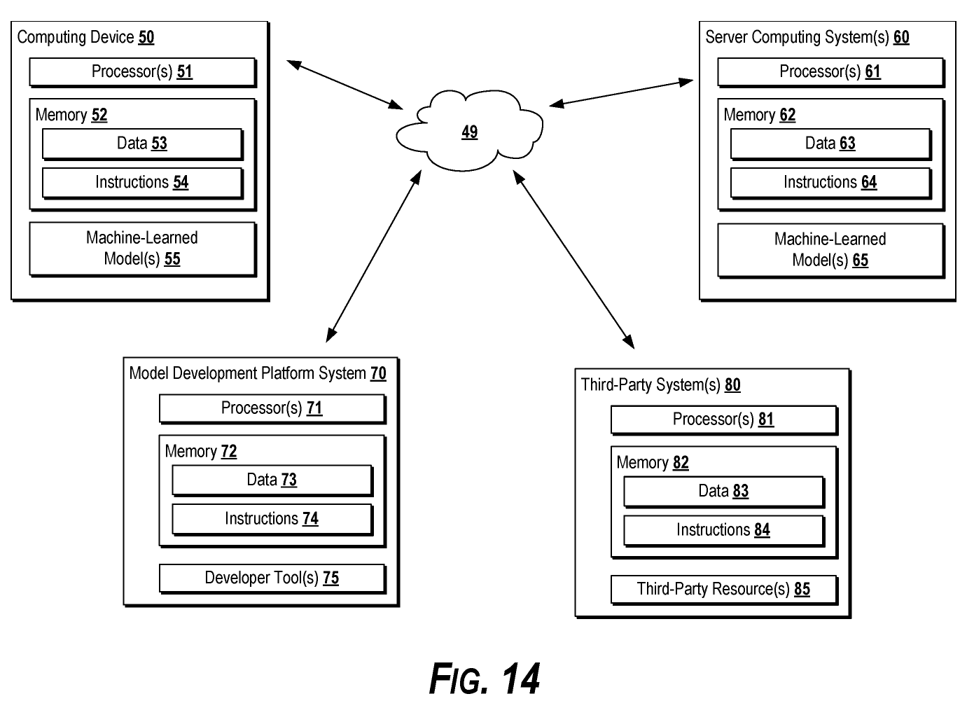

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on or in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model can generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task can be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task can be an audio compression task. The input can include audio data and the output can be or can include compressed audio data. In another example, the input includes visual data (e.g. one or more images or videos), the output includes compressed visual data, and the task is a visual data compression task. In another example, the task can include generating an embedding for input data (e.g. input audio or visual data). In some cases, the input includes audio data representing a spoken utterance and the task is a speech recognition task. The output can be or can include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

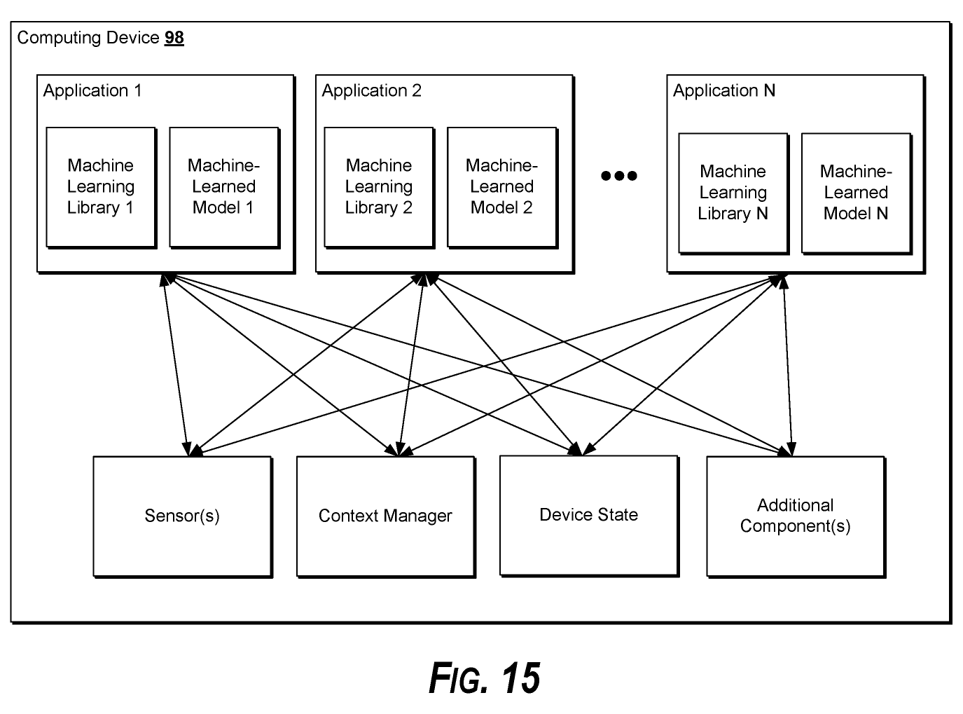

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who can use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

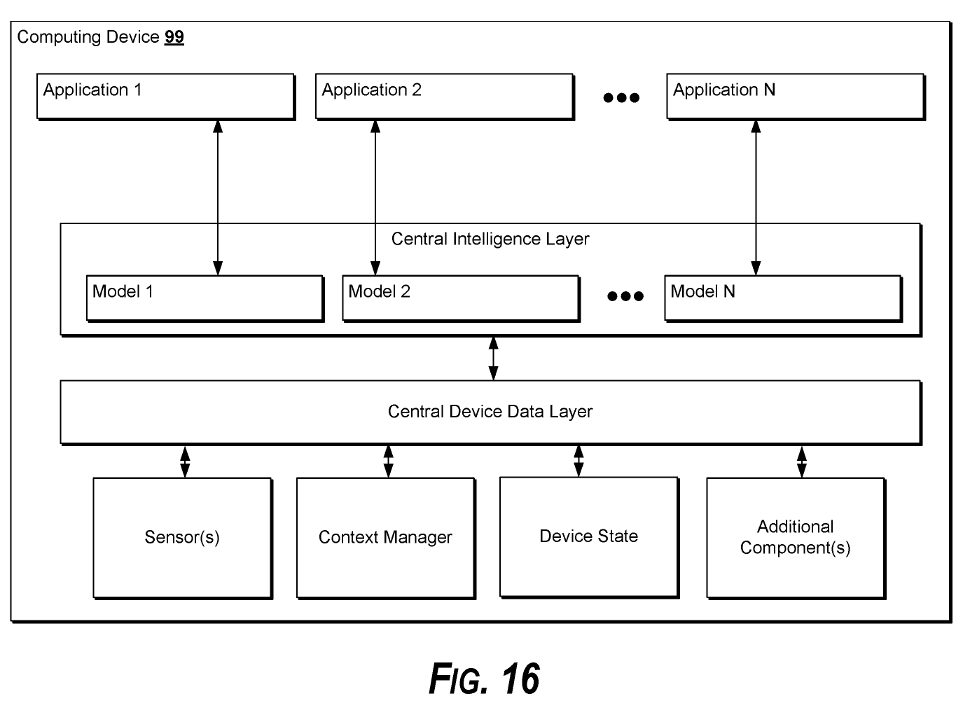

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for training an agent system, comprising:
training a representation generation model on first training data descriptive of context shifts between a plurality of contexts of a computing system and training a plurality of action prediction policies respective to the plurality of contexts on second training data descriptive of a plurality of tasks;
initializing a policy routing model using the plurality of action prediction policies;
training the policy routing model to route control representations between the plurality of action prediction policies; and
performing an inference task using the agent system.

2. The computer-implemented method of claim 1, wherein the plurality of contexts comprise independent environments of the computing system.

3. The computer-implemented method of claim 1, wherein the policy routing model comprises a transformer decoder-only model.

4. The computer-implemented method of claim 1, wherein the first training data and the second training data comprise tuples of observation, state, and action data.

5. The computer-implemented method of claim 1, wherein the second training data is transformed to correspond to encoded representations output by the representation generation model.

6. The computer-implemented method of claim 1, wherein the first training data comprises context shift representations indicative of context shifts within the first training data.

7. The computer-implemented method of claim 1, wherein the second training data comprises compos control representations that signal composition of objectives from action representations.

8. The computer-implemented method of claim 1, further comprising training the representation generation model and the policy routing model end-to-end using third training data descriptive of tasks that utilize at least two of the plurality of action prediction policies.

9. The computer-implemented method of claim 8, wherein training the representation generation model and the policy routing model end-to-end comprises assessing a reward based on at least one of a number of actions, a complexity of actions, a quality, or a latency.

10. The computer-implemented method of claim 1, wherein the representation generation model comprises an encoder-only vision-language model (VLM).

11. The computer-implemented method of claim 1, wherein a vocabulary of the policy routing model comprises one or more reserved representations.

12. A computing system, comprising:
one or more processors; and
one or more non-transitory, computer-readable media storing instructions that, when implemented, cause the one or more processors to perform operations, the operations comprising:
training a representation generation model on first training data descriptive of context shifts between a plurality of contexts and training a plurality of action prediction policies respective to the plurality of contexts on second training data descriptive of a plurality of tasks;
initializing a policy routing model using the plurality of action prediction policies;
training the policy routing model to route representations between the plurality of action prediction policies; and
performing an inference task using the representation generation model and the policy routing model.

13. The computing system of claim 12, wherein the representation generation model comprises an encoder-only vision-language model (VLM).

14. The computing system of claim 12, wherein the plurality of contexts comprise independent environments of the computing system.

15. The computing system of claim 12, wherein the policy routing model comprises a transformer decoder-only model.

16. The computing system of claim 12, wherein the first training data and the second training data comprise tuples of observation, state, and action data.

17. The computing system of claim 12, further comprising training the representation generation model and the policy routing model end-to-end using third training data descriptive of tasks that utilize at least two of the plurality of action prediction policies.

18. The computing system of claim 12, wherein the first training data comprises context shift representations indicative of context shifts within the first training data.

19. The computing system of claim 12, wherein the second training data comprises compose control representations that signal composition of objectives from action representations.

20. One or more non-transitory, computer-readable media storing instructions that, when implemented, cause one or more processors to perform operations, the operations comprising:
receiving a request from a computing system to control the computing system over a plurality of contexts;
outputting, by a representation generation model, a first representation indicative of a first context of the plurality of contexts;
determining, by a policy routing model, to control the computing system using a first expert model based on the first representation, wherein the first expert model is a learned model configured to control the computing system in the first context;
responsive to a context shift of the computing system to a second context of the plurality of contexts, outputting, by the representation generation model, a second representation indicative of the second context; and
determining, by the policy routing model, to control the computing system using a second expert model based on the second representation, wherein the second expert model is a learned model configured to control the computing system in the second context.
